(19) United States
(12) Patent Application Publication
(10) Pub. No.: US 2019/0190721 A1
(43) Pub. Date: Jun. 20, 2019

(54) EMAIL VERIFICATION METHOD

(71) Applicant: Jeremy Machet, Bentleigh, Victoria 3204 (AU)

(72) Inventor: Jeremy Machet, Bentleigh, Victoria 3204 (AU)

(21) Appl. No.: 16/322,980

(22) PCT Filed: Aug. 10, 2017
(86) PCT No.: PCT/AU2017/050846

§ 371 Date: Feb. 4, 2019

(30) Foreign Application Priority Data
Aug. 14, 2016 (AU) 2016903205

(51) Int. Cl. H04L 9/32; H04L 9/08; G06F 21/64; H04L 29/06

(52) U.S. Cl. CPC H04L 9/3239; H04L 9/0894; H04L 9/0643; H04L 63/123; G06F 21/645

(57) ABSTRACT

The invention is a method of verifying one or more emails sent by a valid sender to an intended recipient. One or more encrypted hash codes are computed from the email content and a private encryption key. The one or more hash codes are stored in an encryption memory, along with the data used to generate the one or more hash codes. The one or more hash codes are sent with the email content to the intended recipient. A verification request email is then received, containing a forwarded copy of the sent email. One or more verification hash codes are recomputed using the forwarded copy, and compared with the one or more hash codes stored in the encryption memory. A verification signal disclosing the verification result is sent to the intended recipient, via a non-email route.

### FIELD

The present invention relates to email security, particularly where a recipient wishes to verify that an email purporting to come from a sender is genuine.

### BACKGROUND

A popular medium of data attack known as Spear Phishing is used to target customers of major corporate entities. It is often the case that these attacks collect key identifying information of customers which allows identity fraud stealing property of the customer.

A common scenario is that a database of the company is hacked and an adversary collect information such as customer names and emails. The adversarial then creates a phishing email purporting to come from a corporate. With spear phishing, the email can even include personal information. Typically, the email contains links which if the customer clicks on them will generate a virus or ransomware, or may direct the customer to provide secret credit card or other information.

While corporations are constantly alerting customers to beware of fake emails and ask customers to check the origin of an email, the situation is not assisted by the fact that corporations often use many different genuine email addresses and it is not possible even for an experienced computer user to tell whether an email address is genuinely from the company.

There is a need for a simple system by which a customer can verify that an email received is genuine. While some systems have been proposed in the past, such systems have been cumbersome or insecure. There is therefore a need to provide an improved verification method able to be accessed by any customer with minimal knowledge of computer systems.

The inventor has conceived a system with a high degree of security which is able to be accessed by any person knowing how to forward an email and knowing or having access to a verification email address and a non-email form of communication.

### SUMMARY OF THE INVENTION

Therefore in accordance with a broad aspect of the invention there is provided a method of generating and verifying one or more emails sent by a valid sender to an intended recipient, the method comprising the steps of:

receiving from the valid sender a content of a recipient email and a recipient email address;

generating one or more encrypted hash codes using a hash code generating algorithm, the hash code generating algorithm utilising a private encryption key and the content of the recipient email or metadata of the recipient email;

storing in an encryption memory the one or more encrypted hash codes or information enabling regeneration of the one or more encrypted hash codes;

generating the recipient email comprising the content of the recipient email augmented with the one or more encrypted hash codes;

sending the recipient email to an intended recipient email address;

receiving a verification request email from a verification requestor email address, the verification request email comprising a purported forwarded copy of an email sent by the valid sender to the intended recipient;

determining a verification result according to a verification criterion requiring at least for a positive result that there is a concordance according to a comparison criterion between each of: (1) one or more generated test hash codes obtained using the hash code generating algorithm utilising the private encryption key and content or metadata of the purported forwarded copy; (2) one or more purported encrypted hash codes extracted from the purported forwarded copy; and (3) the one or more encrypted hash codes obtained or regenerated from the encryption memory; and

sending a verification signal disclosing the verification result to the intended recipient by a non-email route.

In one embodiment, the hash code generating algorithm utilises meta data of the recipient email.

In one embodiment, ***<details of other claims to entered once finalised>*****

### BRIEF DESCRIPTION OF DRAWINGS

FIG. 1 is a functional block diagram of a system embodying the method of the invention;

FIG. 2 is a flow diagram of method steps of the invention.

FIG. 3 is an example forwarded email layout of an embodiment of the invention

### DETAILED DESCRIPTION OF EMBODIMENTS

An embodiment of the current invention will now be described.

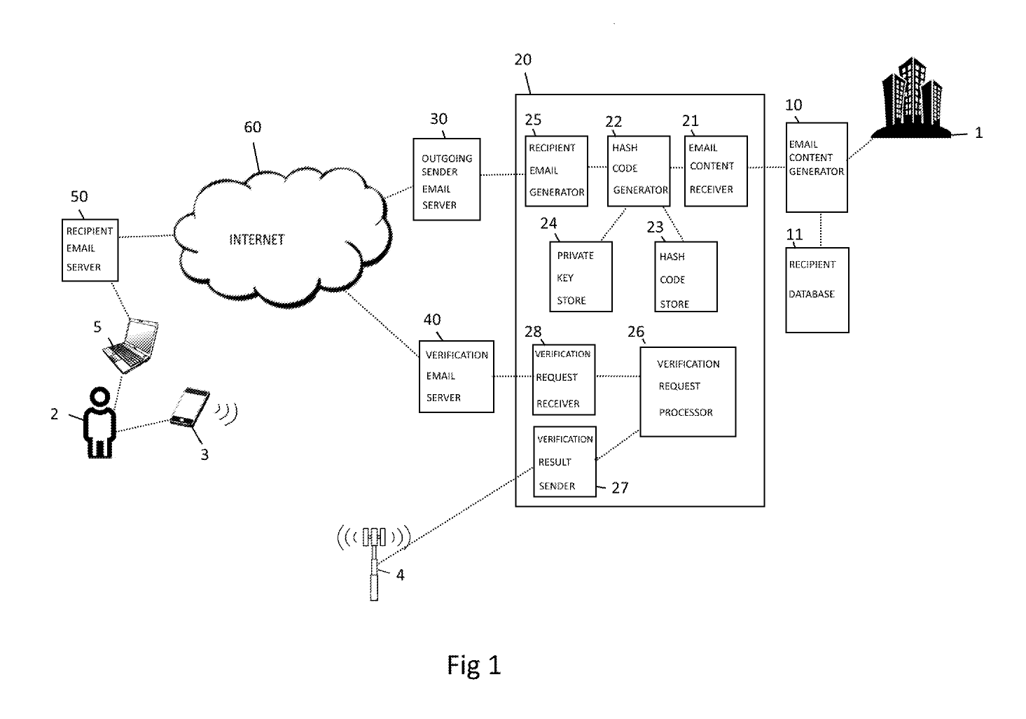

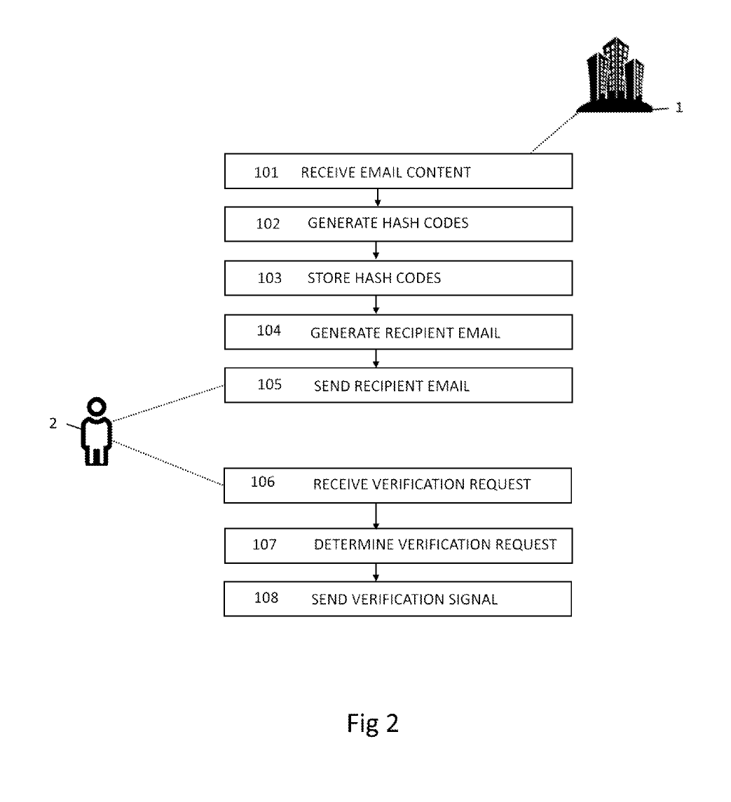

Referring first to FIG. 1, a functional block diagram of a system embodying the invention is shown. Referring also to FIG. 2, method steps 101-108 are shown and referred to below.

Sender 1 maybe a person, corporation or other entity capable of causing content to be generated for an email in an email content generator 10 with access to a recipient database 11 containing at least email address details of at least one intended recipient 2. Typically, sender 1 is a corporation such as a bank or finance provider providing service to multiple customers each of whom are separate recipients of emails generated by email content generator 10. Email content generator 10 may be a word processor program operated by a person or may be a fully or partly automated content generator capable of generating single or multiple batch emails to one or more recipients 2.

Screening system 20 embodies the method steps of the invention and is typically implemented in an Internet-connected computer housed in a secure location controlled and monitored by sender 1 and protected against intrusion from hackers by firewalls and other software and hardware protection. Screening system 20 is interposed between sender 1 and outgoing sender email server 30. Screening system 20 is also in communication with verification email server 40 through which verification requests are received from recipient 2 as described in more detail below. Screening system 20 comprises several software and hardware components 21-27 which are typically located in the same physical location but may be implemented as a distributed architecture in several disparate locations as will be appreciated by a person skilled in the art.

Email content generator 10 is in data communication with screening system 20 through email content receiver 21 which is programmed to implement method step 101 to receive the supplied content of the recipient email as well as a recipient email address which may be obtained from recipient database 11 and provided by email content generator 10 or may be accessed independently by email content receiver 21 through recipient database 11.

Hash code generator 22 is programmed to implement method step 102 of generating one or more encrypted hash codes using a hash code generating algorithm such as SHA256, which generates a 256 bit hash code from a character string input. Being a 256 bit hash, there is a negligible chance that different character strings can generate the same hash and therefore the chance of lucky generation of a valid hash using a different character string is negligible.

The character string includes a private encryption key which may be stored in private key store 24 in screening system 20, preventing other parties duplicating the hash code generating algorithm. The private encryption key may be a password or constant random number common for all generated hash codes and may be periodically changed for added security. Naturally, if the private encryption key is changed a record must be kept after generating each hash code as to which private encryption key was used in the generation. In other embodiments, private encryption key could be a random number generated for each hash code, in which case each private encryption key could be stored as an indexed list in private encryption key store 24 referencing the list of hash codes generated.

The character string also includes information particular to the recipient email. In this embodiment, the information particular to the recipient email is metadata apart from the message body, such as email address, date sent and subject which is separate from the email message body of the recipient email and appears at the top of the body of a forwarded email when the recipient forwards the recipient email.

For example, the character string structure can be a concatenation of the private encryption key, a date, the recipient email address and the subject line, for example:
1372554+12/01/2015+johndoe@gmail.com+subjectline

It is advantageous to use metadata rather than content in the message body, since many email servers may legitimately change the format of or truncate the message body content. Because of this, the message body content is not wholly constant in normal email transmission.

The use of the date of sending the email is a valuable inclusion in the character string because any strategy attempting to generate a fake email from an existing valid email will be constrained by the date. In this embodiment, hash code generator 22 incorporates a date tolerance feature adapted to be insensitive to certain differences in the date of sending the recipient email sufficient to allow for delays or time zone differences. To achieve this, in this embodiment hash code generator 22 generates three hash codes using three corresponding character strings differing by the value of the date, being the date the email was sent, the day before and the day after.

Date tolerance is an important preferred feature of the invention because if a date of sending is to be used there are implementation issues. First, the hash code generator must insert the date at the time of generation of the hash code, which must of necessity be before the actual sending the email and potentially could be one day earlier than the actual date stamp appearing on the sent email due to delays in sending or an email generation occurring just before midnight. Second, because email servers use local time, the date will appear differently in different time zones. Accordingly, a valid date of sending appearing on a forwarded email can be one day earlier or later than the date recorded in a single hash. In this embodiment, this issue is addressed by generating the three hashes, one or two of which must match in the verification process to be described below.

In method step 103, the generated hash codes are stored in hash code store 23, typically indexed according to the recipient in the case where there are multiple recipients such as account holders to be communicated with by the sender, in respect of the same or similar email content. Alternatively or in addition, the content or meta data of the recipient email which was used to generate the hash codes may be stored in hash code store 23, being sufficient to regenerate on demand the generated hash codes using the private encryption key.

In method step 104, the recipient email is generated by recipient email generator 25, by inserting into the message body the one or more hash codes generated by hash code generator 22 to the email content received by email content receiver 21 and passing the message body, email destination and subject to outgoing sender email server 30. Outgoing sender email server 30, which may be owned by a commercial provider such as Google or Microsoft or may be a proprietary email server, then sends the recipient email to the recipient email address in the normal manner.

Intended recipient 2 receives the recipient email on computer 5 through recipient email server 50. Intended recipient 2 is aware of a service provided by sender 1 to enable intended recipient 2 to confirm that the recipient email was sent by sender 1. The service is accessible by the intended recipient 2 forwarding the email through recipient email server 50 to a verification system email address. Typically, this is a dedicated email address including the well-known domain name of the sender such as verify@ABCbank.com. Intended recipient 2 simply clicks the email forward button and specifies the verification system email address as the destination. Alternatively, if the verification system email address is the same as a general purpose email address of the sender, the verification request could be identified by text such as PLEASE VERIFY typed into the body of forwarded email by intended recipient 1.

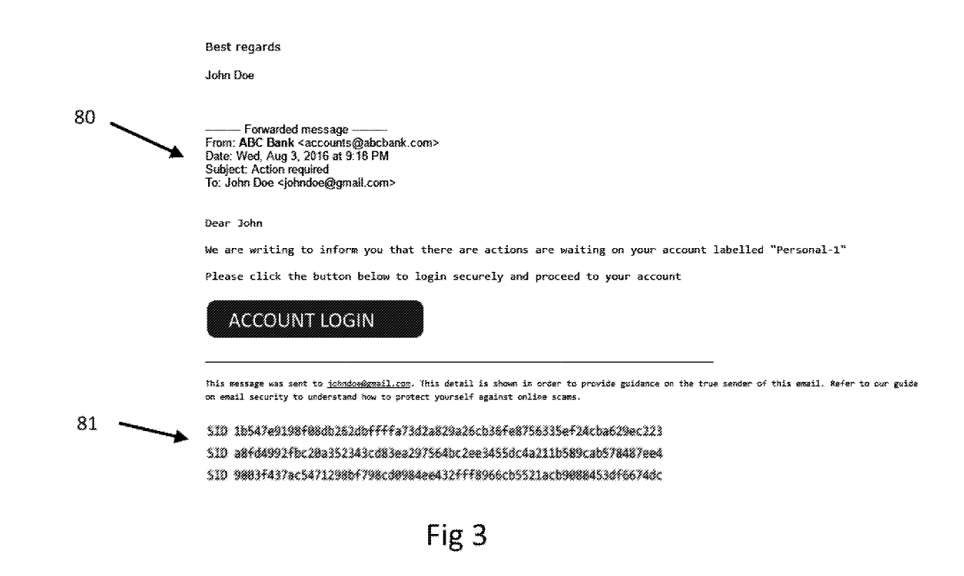

Verification request receiver 28 performs step 106 of receiving the verification request email comprising a purported forwarded copy of the recipient email, example of which is shown in FIG. 3 forwarded from intended recipient email address johndoe@gmail.com. Verification request receiver 28 passes the verification request email to verification request processor 26.

Verification request processor 26 performs step 107 of determining a verification result. The verification result is determined according to a verification criterion which requires at least for a positive result a concordance (or match) according to a comparison criterion between the following 3 sources of hash codes: (1) generated test hash codes; (2) purported encrypted hash codes and (3) the stored hash codes. Naturally, if any two of these three sources do not match then the method does not necessarily have to compute the third to provide a negative verification result. Each of these 3 sources are further discussed below.

(1) Generated Test Hash Codes.

The one or more generated test hash codes are obtained using the hash code generating algorithm, building the character string utilising the private encryption key and content or metadata of the purported forwarded copy. The verification request processor 26 extracts the private encryption key from private key store 24 and the content or meta data from the verification request email, generates the appropriate one or more concatenated character strings and uses the hash code algorithm to generate the one or more test hash codes. In the case of the metadata as in this embodiment such as date of sending, email address and subject, this is found in the text under the heading “forwarded message” in the purported forwarded copy, shown as item 80 in FIG. 3.

(2) Purported Encrypted Hash Codes.

This is the one or more hash codes in the body of the forwarded email purporting to be the hash codes inserted in the recipient email by hash code generator 22 and recipient email generator 25. The verification request processor 26 simply searches for the identifying text “SID” in the body of the email and extracts the one or more purported encrypted or more hash codes. This is shown as item 81 in FIG. 3, where three 256 bit hash codes of this embodiment are shown represented in hexadecimal.

(3) Stored Hash Codes.

These are the hash codes which were stored in the hash code store 23, or regenerated by verification request processor 26 from the information enabling regeneration referred to in step 103 above stored in hash code store 23.

An appropriate comparison criterion in the case of single hash codes is simply that all three hash codes must be equal. In the current embodiment, because there are three hash codes the comparison criterion is different. Clearly, the three purported encrypted hash codes must all be the same as the three stored hash codes, because they purport to be the actual codes inserted in the email. However if the recipient is in a different time zone and/or if there was a delay in original transmission by the outgoing sender email server 30, then only two of the three generated test hash codes may match with two of the three stored hash codes (or equivalently two of the three purported hash codes). Consequently, the comparison criterion may require in respect of the generated test hash codes that only two or three of the three generated test hash codes match the stored or purported hash codes. There may be circumstances where the appropriate test is that at least one of the three generated test has codes match. In other embodiments there may be a set of N>3 hash codes generated, in the same way together covering a contiguous set of dates around the date of sending recipient email, and the comparison criterion may require a number between 1 and N−1 for the partial match.

The verification criterion requires at least for a positive result the concordance discussed above. This may not be a sufficient condition in embodiments which include additional checks to guard against diverse forms of attack. For example, the verification criterion may also require for a positive result certain information obtainable from the header of the verification request email, such as (1) that the email address from which the verification request email was sent matches with the intended recipient email address, (2) that the verification request email was sent using a cryptographic protocol connection such as TLS, SSL or S-MIME. or (3) that an inspection of the body of the forwarded email reveals no unauthorised hyperlinks or attachments.

When the operation of the verification criterion produces a result, the verification result (typically a binary result such as positive or negative, but may be more informative) is disclosed to the intended recipient through verification result sender 27 by a non-email route. In this embodiment, the non-email route is a mobile telephone network 4 and the verification signal is a text message. In other embodiments, the non-email route may be a fixed line telephone number and the verification signal may be an automated or human generated voice or other audio message. In still other embodiments, the non-email route may be a mobile data network and the verification signal may be a push notification or other notification to an application running on a mobile device of the intended recipient 2. The requirement of a non-email route adds an element of two-factor authentication which guards against the situation in which a person's email account is compromised.

Persons skilled in the art will appreciate that many variations may be made to the invention without departing from the scope of the invention, which is determined from the broadest scope and claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention. Further, any method steps recited in the claims are not necessarily intended to be performed temporally in the sequence written, or to be performed without pause once started, unless the context requires it.

It is to be understood that, if any prior art publication is referred to herein, such reference does not constitute an admission that the publication forms a part of the common general knowledge in the art, in Australia or any other country.

1. A method of generating and verifying one or more emails sent by a valid sender to an intended recipient, the method comprising the steps of:
receiving from the valid sender a content of a recipient email and a recipient email address;
generating one or more encrypted hash codes using a hash code generating algorithm, the hash code generating algorithm utilizing a private encryption key and the content of the recipient email or meta data of the recipient email;
storing in an encryption memory the one or more encrypted hash codes or information enabling regeneration of the one or more encrypted hash codes;
generating the recipient email comprising the content of the recipient email augmented with the one or more encrypted hash codes;
sending the recipient email to an intended recipient email address;
receiving a verification request email from a verification requestor email address, the verification request email comprising a purported forwarded copy of an email sent by the valid sender to the intended recipient;
determining a verification result according to a verification criterion requiring at least for a positive result that there is a concordance according to a comparison criterion between each of: (1) one or more generated test hash codes obtained using the hash code generating algorithm utilizing the private encryption key and content or meta data of the purported forwarded copy; (2) one or more purported encrypted hash codes extracted from the purported forwarded copy; and (3) the one or more encrypted hash codes obtained or regenerated from the encryption memory; and
sending a verification signal disclosing the verification result to the intended recipient by a non-email route.

2. The method of claim 1, wherein the hash code generating algorithm utilizes meta data of the recipient email.

3. The method of claim 2, wherein the hash code generating algorithm utilizes a date of sending the recipient email.

4. The method of claim 3, wherein the hash code generating algorithm also utilizes the intended recipient email address.

5. The method of claim 3, wherein the hash code generating algorithm also utilizes a subject line of the recipient email.

6. The method of claim 3, incorporating a date tolerance feature whereby the hash code generating algorithm and the comparison criterion are together adapted to be insensitive to certain differences in the date of sending the recipient email sufficient to allow for delays or time zone differences.

7. The method of claim 6, wherein the date tolerance feature is provided by:
the hash code generating algorithm generating three or more of the one or more encrypted hash codes, each of the encrypted hash codes utilizing a different date of sending the recipient email so that all the encrypted hash codes together cover a contiguous set of dates around the date of sending the recipient email; and
the comparison criterion resulting in concordance when the three or more of the one or more encrypted hash codes are the same as a corresponding three or more purported hash codes, and a partial match between the three or more of the one or more encrypted hash codes and a corresponding three or more generated test hash codes.

8. The method of claim 1, wherein the non-email route is a mobile telephone network and the verification signal comprises a text message.

9. The method of claim 1, wherein the non-email route is a mobile data network and the verification signal comprises a push notification.

10. The method of claim 1, wherein the hash code generating algorithm is an SHA algorithm.

11. The method of claim 1, wherein the step of storing comprises storing the one or more encrypted hash codes.

12. The method of claim 11, wherein the step of storing comprises indexing the one or more encrypted hash codes with information identifying the intended recipient to facilitate retrieval.

13. The method of claim 1, wherein the step of storing comprises storing content or meta data of the recipient email sufficient to regenerate the one or more encrypted hash codes with the private encryption key.

14. The method of claim 1, wherein there is more than one intended recipient receiving different or similar ones of the one or more emails and the private encryption key is the same for all the intended recipients and all of the one or more emails during at least a time period until the private encryption key is changed.

15. The method of claim 1, wherein the verification criterion also requires for a positive verification result that the verification requestor email address is the same as the intended recipient email address.

16. The method of claim 1, wherein the verification criterion also requires for a positive verification result that the verification request email was sent using a cryptographic protocol connection.

17. The method of claim 1, wherein the verification criterion also requires for a positive verification result that a step of inspecting the purported forwarded copy for unauthorized hyperlinks is performed and no unauthorized hyperlinks are found.

18. The method of claim 1, wherein the step of generating a recipient email comprises inserting content of the recipient email together with the one or more encrypted hash codes into a body of the recipient email.
